(19) United States
(12) Patent Application Publication
(10) Pub. No.: US 2025/0303997 A1
(43) Pub. Date: Oct. 2, 2025

(54) CURTAIN AIRBAG DEVICE

(71) Applicant: TOYODA GOSEI CO., LTD., Kiyosu-shi (JP)

(72) Inventors: Ryoichi KATO, Aichi (JP); Hiroyuki NAKANISHI, Aichi (JP); Kyoshiro SHOJI, Aichi (JP)

(21) Appl. No.: 19/090,568

(22) Filed: Mar. 26, 2025

(30) Foreign Application Priority Data
Mar. 27, 2024 (JP) 2024-050860

(51) Int. Cl. B60R 21/232

(52) U.S. Cl. CPC B60R 21/232

(57) ABSTRACT

A curtain airbag device for a moving body includes: an airbag configured to be inflated and deployed by being supplied with inflation gas from an inflator, the airbag having an insertion port into which the inflator is inserted; and a reinforcing portion that reinforces the insertion port to maintain an open state where the insertion port is opened in a cylindrical shape.

### CROSS-REFERENCE TO RELATED APPLICATIONS

This application is based on and claims priority under 35 USC 119 from Japanese Patent Application No. 2024-50860 filed on Mar. 27, 2024, the entire content of which is incorporated herein by reference.

### TECHNICAL FIELD

The present disclosure relates to a curtain airbag device.

### BACKGROUND ART

Regarding a curtain airbag device for a moving body, JP2012-232664A discloses that an inflator is inserted into an insertion port formed of a base fabric of an airbag.

### SUMMARY OF INVENTION

In an insertion step of inserting an inflator into the airbag, it is necessary to insert the inflator into a widened insertion port while widening the insertion port so that the inflator can be inserted. As a result, the insertion step takes time and effort.

The present disclosure may be implemented by the following aspects.
(1) According to an aspect of the present disclosure, it is provided a curtain airbag device for a moving body including: an airbag configured to be inflated and deployed by being supplied with inflation gas from an inflator, the airbag having an insertion port into which the inflator is inserted; and a reinforcing portion that reinforces the insertion port to maintain an open state where the insertion port is opened in a cylindrical shape.

According to this aspect, since an open state is maintained by a reinforcing portion, it is possible to reduce time and effort in an insertion step of inserting an inflator into an insertion port.
(2) In the above aspect, the reinforcing portion may be formed of a ring-shaped member, and
   at least a part of the ring-shaped member is disposed in the insertion port.

According to this aspect, since the open state is more appropriately maintained by a ring-shaped member, it is possible to effectively reduce the time and effort in the insertion step.
(3) In the above aspect, the ring-shaped member includes a first ring-shaped portion and a second ring-shaped portion connected to the first ring-shaped portion in an axial direction of the ring-shaped member, the first ring-shaped portion may be disposed inside the airbag via the insertion port, and
   the second ring-shaped portion may be disposed outside the airbag.

According to this aspect, the ring-shaped member may be easily inserted into the insertion port by inserting a first ring-shaped portion into the airbag from the insertion port while gripping a second ring-shaped portion. Therefore, a step of inserting the ring-shaped member into the insertion port may be simplified.
(4) In the above aspect, a recess may be provided on an outer surface of a side wall of the second ring-shaped portion.

According to this aspect, in the step of inserting the ring-shaped member into the insertion port, the second ring-shaped portion may be gripped using a recess, and the workability can be improved.
(5) In the above aspect, the second ring-shaped portion may have a polygonal outer shape when viewed in the axial direction.

According to this aspect, the second ring-shaped portion is easily gripped stably, and the workability in the step of inserting the ring-shaped member into the insertion port may be improved.
(6) In the above aspect, the ring-shaped member may have a ring shape having both ends.

According to this aspect, the ring-shaped member can be more easily disposed in the insertion port.
(7) In the above aspect, the reinforcing portion may be formed of a plurality of layers of base fabrics overlapping each other.

According to this aspect, the reinforcing portion may be more simply configured.
(8) In the above aspect, the reinforcing portion may be provided in a mouth portion of the airbag including a distal end on the insertion port side, and the number of layers of the base fabric in the mouth portion may be larger than the number of layers of the base fabric in a portion of the airbag different from the mouth portion.

According to this aspect, a portion of the airbag different from a mouth portion may be configured in a space-saving manner while reinforcing the insertion port more effectively.
(9) In the above aspect, the reinforcing portion may include a layer of a base fabric formed of a recycled resin.

According to this aspect, a base fabric formed of a recycled resin may be effectively used.
(10) In the above aspect, the reinforcing portion may include a layer of a base fabric formed of a cured resin.

According to this aspect, the reinforcing portion may be configured in a space-saving manner.

The present disclosure may be realized in various forms such as a method of manufacturing a curtain airbag device, for example, in addition to the form of the curtain airbag device described above.

### BRIEF DESCRIPTION OF DRAWINGS

Exemplary embodiment(s) of the present invention will be described in detail based on the following figures, wherein:

FIG. 1 is a schematic view illustrating a curtain airbag device for a moving body in a first embodiment;

FIG. 2 is a view illustrating the vicinity of a body inlet;

FIG. 3 is a diagram illustrating a schematic configuration of an inner tube;

FIG. 4 is a diagram illustrating an arrangement of the inner tube with respect to a bag body;

FIG. 5 is an exploded perspective view illustrating the vicinity of a receiving portion in the first embodiment;

FIG. 6 is a front view illustrating the vicinity of the receiving portion in the first embodiment;

FIG. 7 is a first perspective view illustrating a schematic configuration of a ring-shaped member;

FIG. 8 is a second perspective view illustrating the schematic configuration of the ring-shaped member;

FIG. 9 is a flowchart of a preliminary step;

FIG. 10 is a flowchart of an insertion step;

FIG. 11 is a diagram illustrating a schematic configuration of a receiving portion in a second embodiment;

FIG. 12 is a diagram illustrating an inner tube in the second embodiment; and

FIG. 13 is a diagram illustrating a receiving portion in a third embodiment.

### DESCRIPTION OF EMBODIMENTS

### A. First Embodiment

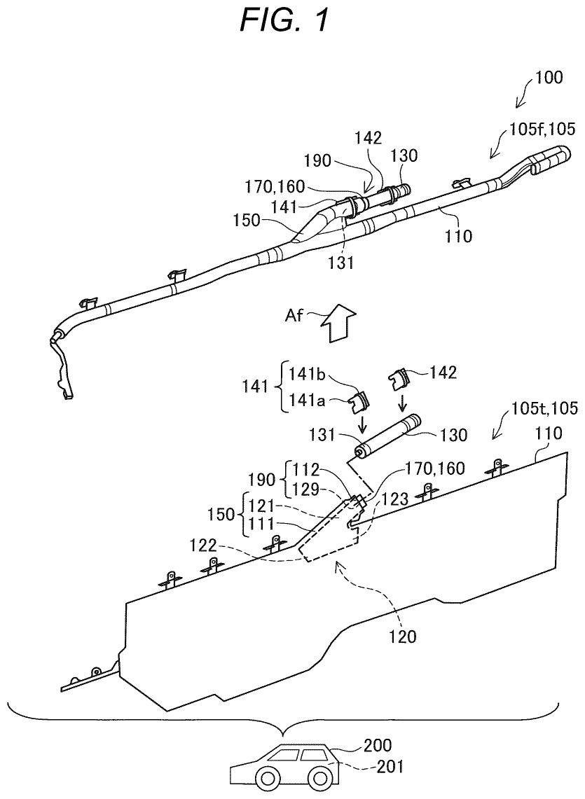

FIG. 1 is a schematic view illustrating a curtain airbag device 100 for a moving body in a first embodiment. FIG. 1 illustrates a right curtain airbag device 100 of a pair of left and right curtain airbag devices 100 attached to a vehicle 200 as a moving body. Here, “left and right” in the present embodiment means left and right when the vehicle 200 is viewed from a rear side to a front side of the vehicle 200. A left-right direction in the present embodiment corresponds to a vehicle width direction.

The curtain airbag device 100 includes an airbag 105, an inflator 130, and a reinforcing portion 160. The airbag 105 includes a receiving portion 150 including an insertion port 190. A distal end portion 131 of the inflator 130 is inserted into the insertion port 190.

When the curtain airbag device 100 is operated, the airbag 105 is inflated and deployed by being supplied with inflation gas from the inflator 130. A state where the airbag 105 is deployed is also referred to as a deployed state. Hereinafter, “when the curtain airbag device 100 is operated” is also simply referred to as “when activated”. The airbag 105 is in a folded state in a normal state when the curtain airbag device 100 is not operated. The folded state means a state where the airbag 105 is not deployed and is folded. FIG. 1 illustrates an airbag 105f in the folded state and an airbag 105t in the deployed state. Specifically, as indicated by an arrow Af in FIG. 1, the airbag 105 takes a folded state by winding a part including a lower end upward and folding another part including an upper end in a zigzag manner from the deployed state.

The receiving portion 150 functions as an inlet for inflation gas to the airbag 105, and receives inflation gas from the inflator 130. In the present embodiment, the receiving portion 150 includes a body inlet 111 and a tube inlet 121, which will be described later. Hereinafter, in the airbag 105, a side closer to the insertion port 190 is also referred to as a “front side”, and a side farther from the insertion port 190 is also referred to as a “back side”.

The airbag 105 in the present embodiment includes a bag body 110 and an inner tube 120. The bag body 110 is a portion that exhibits a function of protecting a protection target by being inflated and deployed by the supplied inflation gas during operation. The deployed state in the present embodiment corresponds to a state where the bag body 110 is deployed. The folded state in the present embodiment corresponds to a state where the bag body 110 is folded. The bag body 110 has a bag-like configuration having a substantially rectangular outer shape. In the present embodiment, the bag body 110 is formed by a so-called one-piece woven method (OPW), and is configured as an integrated bag body woven by an automatic loom. The bag body 110 is formed of a base fabric made of polyethylene terephthalate. In another embodiment, the bag body 110 may be formed by a method different from the OPW, and for example, may be formed by stacking and sewing a plurality of fabrics. 5

The bag body 110 has the body inlet 111. The body inlet 111 is a tubular portion that protrudes rearward and upward on an upper side of the bag body 110 having a substantially rectangular outer shape. The body inlet 111 is a part of the bag body 110, and is formed by forming a part of the fabric configuring the bag body 110 into a tubular shape. A body opening 112 is formed at a distal end of the body inlet 111. The distal end portion 131 of the inflator 130 is inserted into the body opening 112. The above-described “front side” corresponds to a side closer to the body opening 112 in the bag body 110. The “back side” corresponds to a side farther from the body opening 112 in the bag body 110.

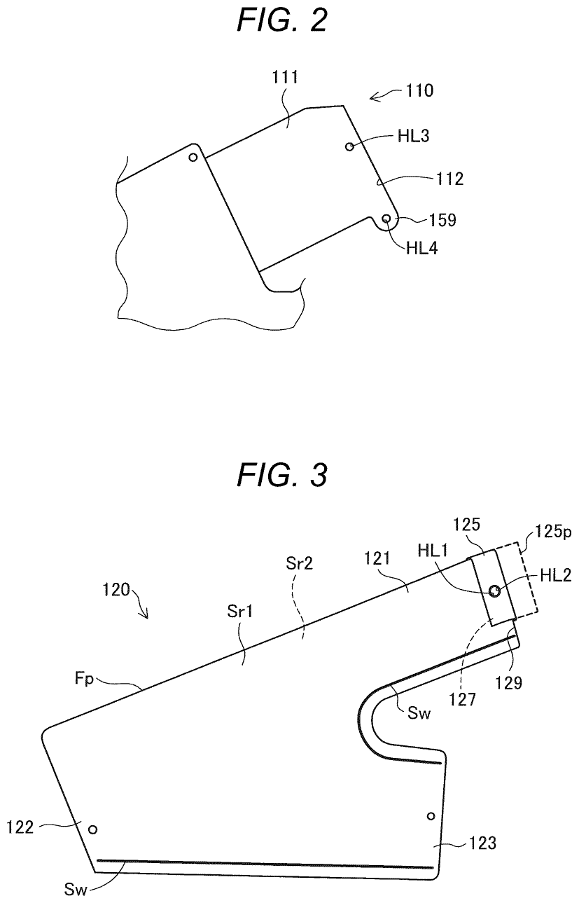

FIG. 2 is a diagram illustrating the vicinity of the body inlet 111 of the bag body 110. As illustrated in FIG. 2, a hole HL3 is provided at a distal end portion of the body inlet 111. The hole HL3 penetrates the distal end portion of the body inlet 111 in a thickness direction of the bag body 110. Two holes HL3 are provided at the distal end portion of the body inlet 111 to be continuous in the thickness direction of the bag body 110. The bag body 110 includes a fastening portion 159. The fastening portion 159 is provided in the vicinity of the body inlet 111. The fastening portion 159 extends from the body inlet 111 in a direction intersecting an axial direction of the body inlet 111 when viewed along the thickness direction of the bag body 110. The fastening portion 159 is provided with a hole HL4.

FIG. 3 is a diagram illustrating a schematic configuration of the inner tube 120. The inner tube 120 controls the flow of inflation gas in the airbag 105 in the vicinity of the receiving portion 150. The inner tube 120 has a tubular shape that branches into two portions in the middle. The inner tube 120 includes a tube inlet 121, a first outlet 122, and a second outlet 123. The first outlet 122 and the second outlet 123 are portions branched from the tube inlet 121. A tube opening 129 is provided at a distal end portion of the tube inlet 121. At least a part of the inner tube 120 is disposed in the bag body 110. Details of the arrangement of the inner tube 120 with respect to the bag body 110 will be described later.

In the present embodiment, the inner tube 120 is formed of a base fabric made of polyethylene terephthalate. The inner tube 120 is formed by appropriately sewing layers of the folded base fabric together. When the inner tube 120 is sewn, first, a base fabric for forming the inner tube 120 is folded in two at a folded portion Fp illustrated in FIG. 3. As illustrated in FIG. 3, the folded portion Fp constitutes a shoulder portion of the inner tube 120 where the base fabric is folded back. Next, the layers of the folded base fabric are sewn together so that each portion of the inner tube 120 such as the tube inlet 121, the first outlet 122, and the second outlet 123 is formed. As a result, the inner tube 120 has a substantially symmetrical shape when viewed from a first surface Sr1 side of the inner tube 120 and when viewed from a second surface Sr2 side opposite to the first surface Sr1. FIG. 3 schematically illustrates a sewn portion Sw formed in the inner tube 120 by the sewing.

The tube inlet 121 in the present embodiment includes a collar portion 125 and an overlapping portion 127. The collar portion 125 is a collar portion of the tube inlet 121 provided at the distal end portion of the tube inlet 121. As illustrated in FIG. 3, the collar portion 125 is folded back toward the second outlet 123. The folded collar portion 125 has a collar shape that covers the distal end portion of the tube inlet 121 to extend over the first surface Sr1 side and the second surface Sr2 side of the tube inlet 121. In FIG. 3, a collar portion 125p in a state before being folded back is schematically illustrated by a broken line. The overlapping portion 127 is a portion where the folded collar portion 125 overlaps in a thickness direction of the inner tube 120. The overlapping portion 127 extends between the first surface Sr1 side and the second surface Sr2 side of the tube inlet 121.

The collar portion 125 has holes HL1 each penetrating the collar portion 125 in the thickness direction. The overlapping portion 127 has holes HL2 each penetrating the overlapping portion 127 in the thickness direction of the inner tube 120. The holes HL1 of the folded collar portion 125 and the holes HL2 of the overlapping portion 127 are disposed to be continuous in the thickness direction of the inner tube 120. For convenience of illustration, only the holes HL1 and HL2 provided on the first surface Sr1 side of the inner tube 120 are illustrated in FIG. 3, but the holes HL1 and HL2 are also provided on the second surface Sr2 side. In the curtain airbag device 100, the thickness direction of the inner tube 120 is the same as a thickness direction of the airbag 105 and the thickness direction of the bag body 110.

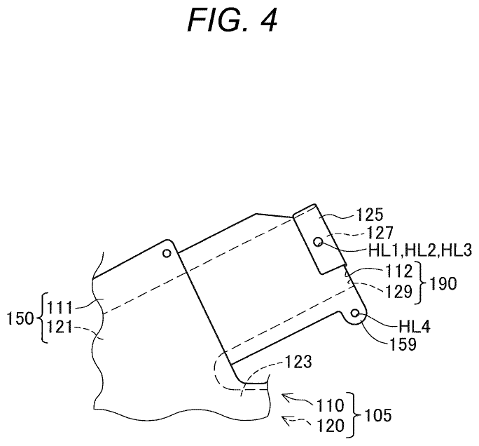

FIG. 4 is a diagram illustrating an arrangement of the inner tube 120 with respect to the bag body 110. FIG. 4 illustrates the vicinity of the receiving portion 150 of the airbag 105. FIG. 4 illustrates the airbag 105 in a state where the inflator 130 and a ring-shaped member 170 as the reinforcing portion 160 to be described later are not disposed.

As illustrated in FIGS. 1 and 4, the first outlet 122 and the second outlet 123 are disposed in the bag body 110. The tube inlet 121 is disposed such that the distal end portion of the tube inlet 121 is located at substantially the same position as the distal end portion of the body inlet 111. In the present embodiment, the tube inlet 121 is disposed such that the distal end portion of the tube inlet 121 slightly protrudes to the outside of the bag body 110 via the body opening 112. As illustrated in FIG. 4, the overlapping portion 127 of the inner tube 120 is disposed to overlap the distal end portion of the body inlet 111 in the body inlet 111. The collar portion 125 is folded back to overlap the distal end portion of the body inlet 111 and the overlapping portion 127 disposed in the body inlet 111. Thus, in a state where the collar portion 125 is folded back, the holes HL1, HL2, and HL3 are continuous in the thickness direction of the airbag 105. Specifically, two holes HL1, two holes HL2, and two holes HL3 are continuous in the thickness direction of the airbag 105.

As illustrated in FIGS. 1 and 4, in the present embodiment, the insertion port 190 is formed by the body opening 112 of the bag body 110 and the tube opening 129 of the inner tube 120. With such a configuration, in the present embodiment, the distal end portion 131 of the inflator 130 is inserted into the body opening 112 by being inserted into the tube opening 129. As a result, the distal end portion 131 is inserted into the insertion port 190. The inflation gas ejected from the inflator 130 inserted into the insertion port 190 is supplied into the bag body 110 along the tube inlet 121, and then flows to a back side in the bag body 110 along the first outlet 122 or the second outlet 123.

The inflator 130 illustrated in FIG. 1 has a function of inflating the bag body 110. The inflator 130 has a substantially columnar shape. The inflator 130 receives a signal from a control unit (not illustrated) of the vehicle 200 and ejects inflation gas from the distal end portion 131.

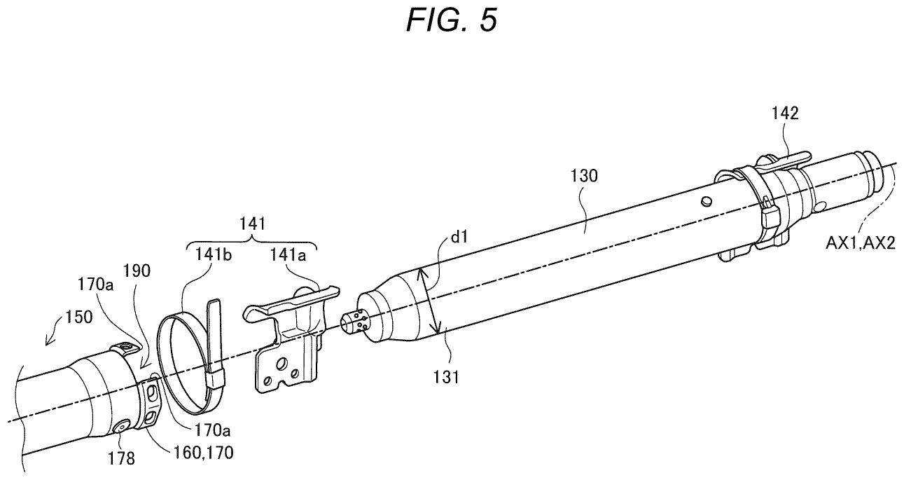

FIG. 5 is an exploded perspective view illustrating the vicinity of the receiving portion 150 of the curtain airbag device 100. As illustrated in FIGS. 1 and 5, in the present embodiment, the inflator 130 is fixed to the vehicle body 201 of the vehicle 200 using a bracket 141 and a bracket 142. In the present embodiment, the distal end portion 131 of the inflator 130 is fixed to the airbag 105 by the bracket 141. The bracket 141 includes a bracket body 141a and a binding portion 141b. The binding portion 141b is configured as a band-like clamp member. The binding portion 141b binds and fixes the body inlet 111, the bracket body 141a, the tube inlet 121, and the distal end portion 131 by being wound from the outside of the receiving portion 150. The binding portion 141b ensures airtightness between the inflator 130 and the airbag 105 to such an extent that the airbag 105 can be appropriately inflated and deployed by the inflation gas. The bracket body 141a is fixed to the vehicle body 201 via fixtures (not illustrated) such as screws and bolts. The bracket 142 is configured similarly to the bracket 141, is bound to a rear end portion of the inflator 130 different from the distal end portion 131, and is fixed to the vehicle body 201 via a fixture.

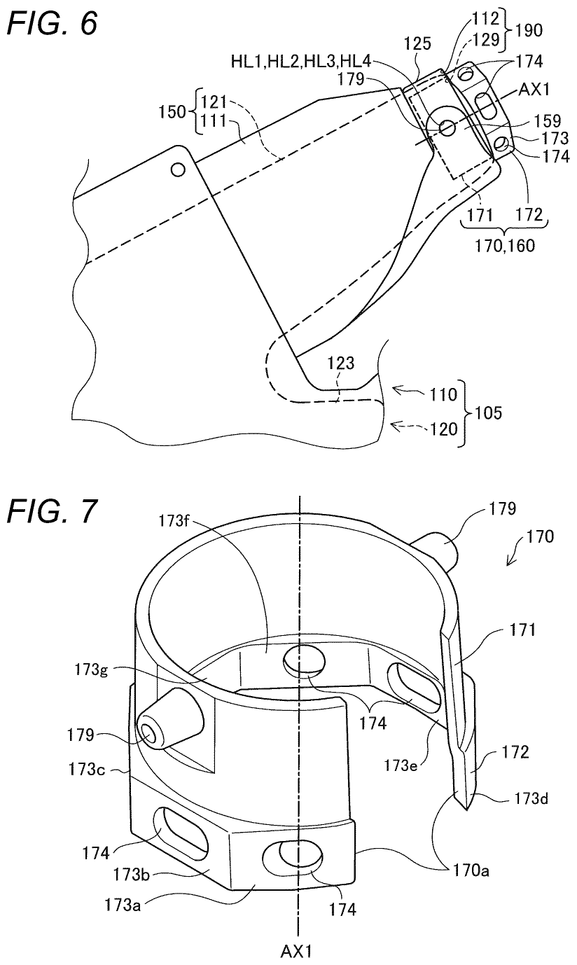

FIG. 6 is a front view illustrating the vicinity of the receiving portion 150 of the curtain airbag device 100. FIG. 6 illustrates the receiving portion 150 in a state where the inflator 130 is not disposed.

As illustrated in FIGS. 1, 5, and 6, the insertion port 190 is provided with the reinforcing portion 160. In the present embodiment, the reinforcing portion 160 is constituted by a ring-shaped member 170. The reinforcing portion 160 reinforces the insertion port 190 to maintain an open state of the insertion port 190. The “open state” means a state where the insertion port 190 is opened in a tubular shape. Specifically, the reinforcing portion 160 maintains the open state of the insertion port 190 in a state where the inflator 130 is not inserted into the insertion port 190 and no external force is applied to the insertion port 190. The “tubular shape” includes various tubular shapes such as a cylindrical shape and a rectangular tube.

A size of an opening of the insertion port 190 whose open state is maintained by the reinforcing portion 160 is preferably a size that allows the distal end portion 131 of the inflator 130 to be smoothly inserted into the insertion port 190. Specifically, for example, an opening diameter of the insertion port 190 whose open state is maintained by the reinforcing portion 160 is preferably equal to or larger than a maximum diameter dl of the distal end portion 131. The opening diameter of the insertion port 190 means a diameter of the narrowest portion of the insertion port 190 when viewed in an axis AX2 direction. The “maximum diameter of the distal end portion” means a diameter of the thickest portion of the distal end portion 131 in the axis AX2 direction.

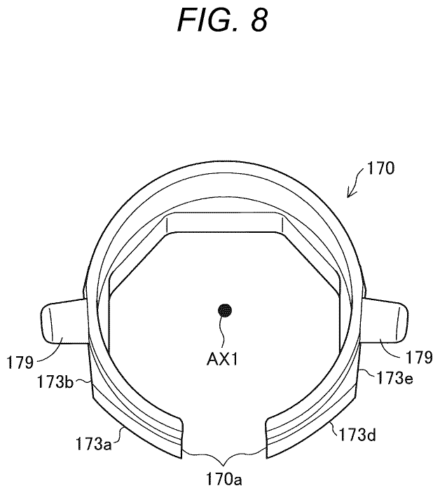

FIG. 7 is a first perspective view illustrating a schematic configuration of the ring-shaped member 170. FIG. 8 is a second perspective view illustrating the schematic configuration of the ring-shaped member 170. The ring-shaped member 170 is made of an olefin-based elastomer (TPO). In another embodiment, the ring-shaped member 170 is not limited to TPO, and may be made of various materials, for example, various resin materials such as ABS resin and polypropylene (PP), or various metals.

In the present embodiment, the ring-shaped member 170 includes a first ring-shaped portion 171 and a second ring-shaped portion 172 in an axis AX1 direction of the ring-shaped member 170. The second ring-shaped portion 172 is connected to the first ring-shaped portion 171 in the axis AX1 direction. At least a part of the ring-shaped member 170 is disposed in the insertion port 190. Specifically, as illustrated in FIG. 6, the first ring-shaped portion 171 is disposed in the airbag 105 via the insertion port 190. More specifically, the first ring-shaped portion 171 is disposed in the inner tube 120 in the bag body 110 via the body opening 112 and the tube opening 129. The second ring-shaped portion 172 is disposed outside the airbag 105. That is, the ring-shaped member 170 is disposed such that a distal end portion of the second ring-shaped portion 172 protrudes to the outside of the airbag 105 via the insertion port 190.

As illustrated in FIGS. 5 to 8, in the present embodiment, the ring-shaped member 170 has a ring shape having both ends. Specifically, the ring-shaped member 170 does not have a complete ring shape but has a C shape when viewed in the axis AX1 direction. That is, the ring-shaped member 170 has two ends 170a when viewed in the axis AX1 direction, and the ring-shaped member 170 is interrupted at each end 170a. As described above, in the present disclosure, the “ring shape” includes not only a continuous ring shape but also a ring shape having both ends. The “ring shape having both ends” includes a ring shape (for example, a semicircular shape) in which both ends extend in the same direction, a ring shape in which one end intersects with the other end when one end is extended, and a ring shape in which both ends intersect with each other when both ends are extended. In the present embodiment, the ends 170a are disposed such that end surfaces of the ends 170a face each other.

In the present embodiment, the second ring-shaped portion 172 has a polygonal outer shape when viewed in the axis AX1 direction. Specifically, the second ring-shaped portion 172 has an octagonal outer shape when viewed in the axis AX1 direction. In the present embodiment, a maximum diameter of the outer shape of the second ring-shaped portion 172 is larger than a maximum diameter of the outer shape of the first ring-shaped portion 171.

In the present embodiment, recesses 174 are provided on an outer surface of a side wall 173 of the second ring-shaped portion 172. The “recess” is a portion in which the outer surface of the side wall 173 is recessed inward toward an axis AX1 side, and includes a bottomed recess or a bottomless recess. The “bottomless recess” corresponds to a through hole penetrating the side wall 173 in the thickness direction of the side wall 173. Each of the recesses 174 is configured as a through hole.

In the present embodiment, six recesses 174 are provided on the outer surface of the side wall 173. In addition, one recess 174 and another recess 174 are disposed to face each other. Specifically, as illustrated in FIG. 7, the side wall 173 includes side walls 173a, 173b, 173c, 173d, 173e, 173f, and 173g corresponding to seven sides of the octagonal outer shape. The recesses 174 are provided one by one from the side wall 173a to the side wall 173f. Each of the side wall 173a and the side wall 173d is a side wall having ends 170a. The side wall 173b is adjacent to the side wall 173a. The side wall 173c is adjacent to the side wall 173b and faces the side wall 173d. The side wall 173e is adjacent to the side wall 173d and faces the side wall 173c. The side wall 173f is adjacent to the side wall 173e and faces the side wall 173a. The side wall 173g is located farthest from the two ends 170a among the seven side walls, and is adjacent to the side wall 173c and the side wall 173f. It can also be said that the side wall 173g is disposed to face a disconnected portion of the side walls of the second ring-shaped portion 172. In each of FIGS. 5 to 7, only some of the six recesses 174 are illustrated for convenience of illustration.

As illustrated in FIGS. 6 to 8, the ring-shaped member 170 in the present embodiment has protrusions 179. FIG. 5 illustrates a plug portion 178 obtained by deforming the protrusions 179 into a plug shape. The protrusions 179 are provided on an outer surface of a side wall of the ring-shaped member 170 and protrudes toward the outside of the ring-shaped member 170, that is, toward a side opposite to the axis AX1. As illustrated in FIGS. 7 and 8, in the present embodiment, two protrusions 179 are provided on a side wall of the first ring-shaped portion 171. The protrusions 179 are provided at a position corresponding to the side wall 173b and a position corresponding to the side wall 173e, and protrude in opposite directions. The protrusions 179 are used to couple the ring-shaped member 170 to the bag body 110 and the inner tube 120. Specifically, as illustrated in FIG. 6, when the protrusions 179 are inserted into the hole HL1, the hole HL2, and the hole HL3, the ring-shaped member 170 is joined to the bag body 110 and the inner tube 120. As illustrated in FIG. 6, a fastening portion 159 of the bag body 110 is further fastened to one of the protrusions 179. Specifically, in addition to the hole HL1, the hole HL2, and the hole HL3, the hole HL4 of the fastening portion 159 is inserted into one of the protrusions 179. The fastening portion 159 is folded back to cover the collar portion 125 overlapping the distal end portion of the body inlet 111, and is fastened to the protrusion 179. Thereafter, the protrusions 179 are deformed into a plug shape by, for example, frictional heat due to vibration or heat due to a heater, whereby the plug portions 178 illustrated in FIG. 5 are formed. The plug portions 178 connect the bag body 110 and the inner tube 120 together to the ring-shaped member 170, and prevent the ring-shaped member 170 from coming off the bag body 110 and the inner tube 120.

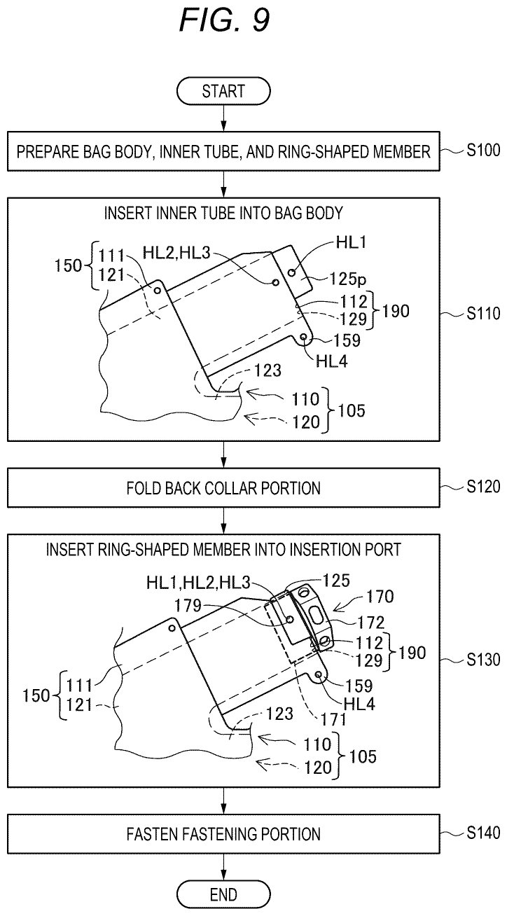

FIG. 9 is a flowchart of the preliminary step. The preliminary step is a step of disposing the ring-shaped member 170 as the reinforcing portion 160. The preliminary step is executed prior to the insertion step. The insertion step is a step of inserting the inflator 130 into the insertion port 190. Each of the preliminary step and the insertion step corresponds to at least a part of a method of manufacturing the curtain airbag device 100 in the present embodiment. Details of the insertion step will be described later.

In step S100, the bag body 110, the inner tube 120, and the ring-shaped member 170 are prepared. In step S110, the inner tube 120 is inserted into the bag body 110. Specifically, in step S110, the inner tube 120 is inserted into the bag body 110 such that the first outlet 122 and the second outlet 123 are disposed in the bag body 110 and the collar portion 125p protrudes to the outside of the bag body 110 through the body opening 112. In step S120, the collar portion 125 is folded back as illustrated in FIG. 4. By executing steps S110 and S120, the inner tube 120 is set in the bag body 110, and the insertion port 190 is formed by the body opening 112 and the tube opening 129.

In step S130, the ring-shaped member 170 is inserted into the insertion port 190. Specifically, the first ring-shaped portion 171 of the ring-shaped member 170 is inserted into the tube opening 129 of the inner tube 120, and the protrusions 179 are inserted into the holes HL1, HL2, and HL3, so that the protrusions 179 protrude from the inside to the outside of the airbag 105 through the holes HL1, HL2, and HL3. A step of inserting the ring-shaped member 170 into the insertion port 190 as in step S130 is also referred to as a preliminary insertion step.

In step 140, the fastening portion 159 is fastened to the protrusion 179. Specifically, in step S140, as illustrated in FIG. 6, the fastening portion 159 is folded back to cover the collar portion 125, and the protrusion 179 is inserted into the hole HL4 provided in the fastening portion 159. Thereafter, as described above, the protrusions 179 are deformed to form the plug portions 178.

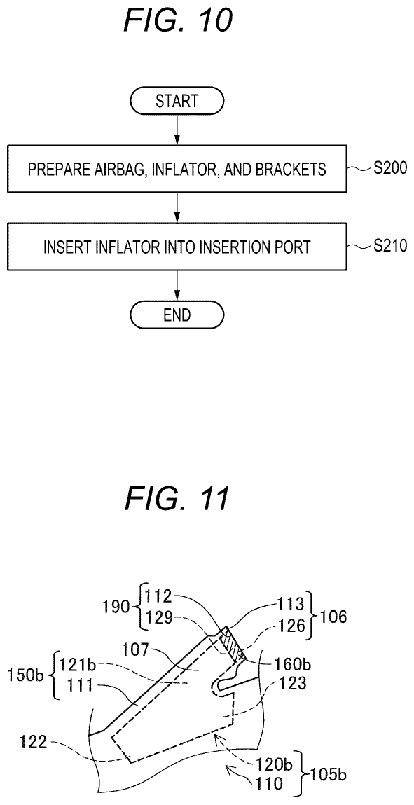

FIG. 10 is a flowchart of the insertion step. In step S200, the airbag 105 in the open state, the inflator 130, and the brackets 141, 142 are prepared. Specifically, in step S200 of the present embodiment, the airbag 105 in a state where step S130 in FIG. 9 is completed is prepared as the airbag 105. In step S210, the inflator 130 is inserted into the insertion port 190 reinforced by the ring-shaped member 170 as the reinforcing portion 160. Thereafter, the brackets 141, 142 are fastened to the inflator 130.

According to the curtain airbag device 100 in the present embodiment described above, since the insertion port 190 is reinforced by the reinforcing portion 160 to maintain the open state, it is possible to reduce the time and effort in the insertion step. For example, when the insertion step is executed manually in another embodiment in which the reinforcing portion 160 is not provided, it is necessary to insert the inflator 130, which is a relatively heavy member, into the widened insertion port 190 while widening the insertion port 190. For example, in the other embodiment in which the reinforcing portion 160 is not provided, in a case where the insertion step is executed without using a hand of an operator, relatively complicated operation control is required to widen the insertion port 190 by a device such as a robot or a work machine. On the other hand, in the present embodiment, as illustrated in FIG. 10, in the insertion step, the inflator 130 may be simply inserted into the insertion port 190 reinforced by the reinforcing portion 160. Therefore, in both the case where the insertion step is executed manually and the case where the insertion step is executed without using the hand of the operator, the time and effort in the insertion step can be reduced.

Further, in the present embodiment, the reinforcing portion 160 is constituted by the ring-shaped member 170 at least a part of which is disposed in the insertion port 190. In this way, the open state is more appropriately maintained by the ring-shaped member 170 as the reinforcing portion 160. Specifically, for example, as compared with a case where the ring-shaped member 170 is disposed outside the insertion port 190 to surround the periphery of the insertion port 190, the closing of the insertion port 190 is easily restricted by the ring-shaped member 170. Therefore, the time and effort in the insertion step can be effectively reduced.

In the present embodiment, the first ring-shaped portion 171 of the ring-shaped member 170 is disposed inside the airbag 105 via the insertion port 190, and the second ring-shaped portion 172 is disposed outside the airbag 105. In this way, the ring-shaped member 170 can be easily inserted into the airbag 105 by inserting the first ring-shaped portion 171 into the airbag 105 from the insertion port 190 while gripping the second ring-shaped portion 172. Therefore, the preliminary insertion step can be simplified. In particular, in the present embodiment, since the maximum diameter of the outer shape of the second ring-shaped portion 172 is larger than the maximum diameter of the outer shape of the first ring-shaped portion 171, only the first ring-shaped portion 171 can be easily inserted into the airbag 105.

In the present embodiment, since the recesses 174 are provided on the outer surface of the side wall 173 of the second ring-shaped portion 172, the second ring-shaped portion 172 can be gripped using the recesses 174 in the preliminary insertion step. For example, the second ring-shaped portion 172 can be gripped by hooking the fingers of the operator on the recesses 174 or hooking a tip of an end effector of a robot on the recesses 174. Therefore, workability in the preliminary insertion step can be improved. In particular, in the present embodiment, since one recess 174 and another recess 174 are provided to face each other, the second ring-shaped portion 172 can be easily sandwiched and gripped from the outside using the recesses 174. Therefore, the workability in the preliminary insertion step can be further improved.

In the present embodiment, the second ring-shaped portion 172 has a polygonal outer shape when viewed in the axis AX1 direction. In this way, for example, compared to a case where the outer shape of the second ring-shaped portion 172 is a curved shape such as a circular shape or an elliptical shape, the second ring-shaped portion 172 is easily stably gripped. As a result, workability in the preliminary insertion step can be improved.

In the present embodiment, the ring-shaped member 170 has a ring shape having both ends. In this way, in the preliminary insertion step, the ring-shaped member 170 can be inserted into the insertion port 190 while temporarily deforming the ring-shaped member 170 such that the ends 170a of the ring-shaped member 170 approach each other. Therefore, for example, as compared with a form in which the ring-shaped member 170 has an annular shape without both ends, the ring-shaped member 170 can be more easily disposed in the insertion port 190. After the distal end portion 131 of the inflator 130 is inserted into the insertion port 190, for example, a pin for filling the inflator 130 with inflation gas can be easily inserted into the insertion port 190 through a gap between the ends 170a. Therefore, even when a filling port for filling the inflation gas is provided in the distal end portion 131, the inflation gas can be easily filled into the inflator 130 inserted into the insertion port 190.

### B. Second Embodiment

FIG. 11 is a diagram illustrating a schematic configuration of a receiving portion 150b in a second embodiment. In the second embodiment, unlike the first embodiment, the ring-shaped member 170 is not provided in the insertion port 190 of the receiving portion 150b. In addition, the reinforcing portion 160b is not formed by the ring-shaped member 170, but is formed of a plurality of layers of base fabric overlapping each other. Hereinafter, the layer of the base fabric is also referred to as a base fabric layer. Points of the configuration of the curtain airbag device 100 in the second embodiment that are not particularly described are the same as in the first embodiment.

The reinforcing portion 160b is provided in a mouth portion 106 of an airbag 105b. The mouth portion 106 is a portion including a distal end of the airbag 105b on an insertion port 190 side. In the present embodiment, the mouth portion 106 is formed by a body distal end portion 113 of the bag body 110 and a tube distal end portion 126 of an inner tube 120b. The body distal end portion 113 is a portion including a distal end of the receiving portion 150 of the bag body 110 on a body opening 112 side. The tube distal end portion 126 is a portion including a distal end of the tube inlet 121b on a tube opening 129 side. In FIG. 11, a range in which the reinforcing portion 160b is provided is schematically illustrated by hatching.

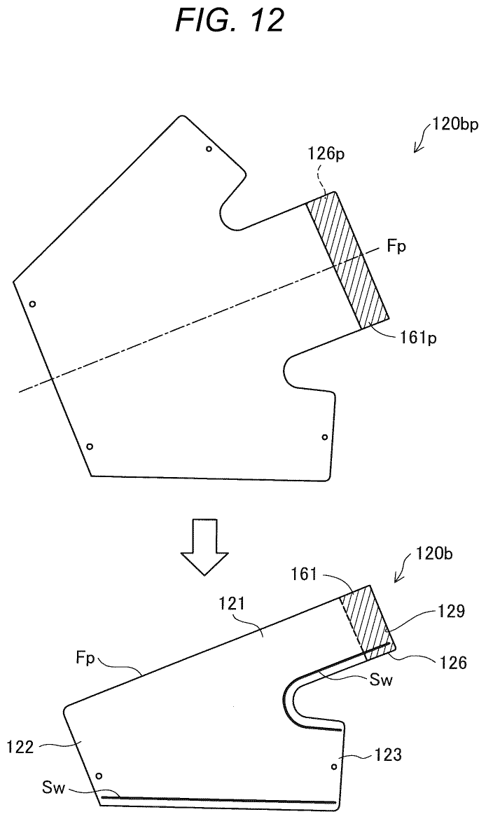

FIG. 12 is a diagram illustrating an inner tube 120b in the second embodiment. FIG. 12 illustrates the inner tube 120b and a pre-sewing inner tube 120bp. The pre-sewing inner tube 120bp is configured as a base fabric for forming the inner tube 120b. As illustrated in the lower part of FIG. 12, in the tube distal end portion 126, a reinforcing layer 161 is further disposed to overlap a base fabric layer forming the entire inner tube 120b. The reinforcing layer 161 includes one or more base fabric layers. In the present embodiment, the reinforcing layer 161 is sewn to a base fabric of the tube distal end portion 126 and is disposed inside the tube distal end portion 126. Here, the “inside” means an inner side in a radial direction of the tube distal end portion 126.

Hereinafter, a step of forming the reinforcing layer 161 in the present embodiment will be described. The step of forming the reinforcing layer 161 corresponds to at least a part of the method of manufacturing the curtain airbag device 100 in the second embodiment. In the step of forming the reinforcing layer 161, first, as illustrated in the upper part of FIG. 12, one or more reinforcing base fabrics 161p for forming the reinforcing layer 161 are superimposed on a distal end forming portion 126p. The distal end forming portion 126p is a portion of the pre-sewing inner tube 120bp that forms the tube distal end portion 126 of the inner tube 120b. Next, the reinforcing base fabrics 161p superposed on the distal end forming portion 126p are sewn to the distal end forming portion 126p. Thereafter, the pre-sewing inner tube 120bp to which the reinforcing base fabrics 161p are sewn is folded in two at the folded portion Fp, and the base fabric layers of the folded pre-sewing inner tube 120bp are sewn together. As a result, the inner tube 120b to which the reinforcing layer 161 is sewn is formed inside the tube distal end portion 126. In FIG. 12, a range in which the reinforcing layer 161 is provided and a range in which the reinforcing base fabrics 161p are provided are each indicated by hatching.

In the present embodiment, each of the reinforcing base fabrics 161p is formed of a recycled base fabric. As a result, the reinforcing layer 161 and the reinforcing portion 160b in the present embodiment include a recycled base fabric layer, which is a layer of the recycled base fabric. The recycled base fabric is a base fabric formed of fibrous recycled resins. Specifically, the recycled base fabric is formed of weaving fibrous recycled resins. The recycled resin is a recycled resin material. The recycled resin may be prepared, for example, by reusing a resin base fabric or by reusing various resin products such as containers.

In the present embodiment, the number of base fabric layers in the mouth portion 106 illustrated in FIG. 11 is larger than the number of base fabric layers in a portion of the airbag 105 different from the mouth portion 106. Specifically, the mouth portion 106 includes a base fabric layer forming the entire bag body 110, a base fabric layer forming the entire inner tube 120, and the reinforcing layer 161. On the other hand, for example, a base portion 107 illustrated in FIG. 11 does not include the reinforcing layer 161. The base portion 107 is a portion of the airbag 105 different from the mouth portion 106, and does not include the distal end of the airbag 105 on the insertion port 190 side. As a result, the number of base fabric layers in the mouth portion 106 is larger than the number of base fabric layers in the base portion 107.

According to the curtain airbag device 100 in the second embodiment described above, the reinforcing portion 160b is formed of a plurality of base fabric layers overlapping each other. Therefore, the reinforcing portion 160b can be more simply configured.

In the present embodiment, the number of base fabric layers in the reinforcing portion 160b is larger than the number of base fabric layers in the base portion 107. Therefore, it is possible to prevent an increase in a thickness of the base portion 107 while more effectively reinforcing the insertion port 190 by the reinforcing portion 160b. In addition, it is possible to prevent a decrease in flexibility of the base portion 107 due to an increase in the thickness of the base portion 107. As a result, for example, as compared with a form in which the number of base fabric layers in the base portion 107 is equal to or greater than the number of base fabric layers in the reinforcing portion 160b, for example, the airbag 105 can be more smoothly inflated and deployed, and the storability of the airbag 105 in the folded state can be improved. In addition, the base fabric can be saved as compared with the form in which the number of base fabric layers in the base portion 107 is equal to or greater than the number of base fabric layers in the reinforcing portion 160b.

In the present embodiment, the reinforcing portion 160b includes a recycled base fabric layer. Here, the durability of the recycled base fabric formed of the recycled resin may be lower than the durability of the non-recycled base fabric, which is a base fabric that does not depend on the recycled resin, due to modification, mixing of impurities, and the like when the resin material is recycled. In the present embodiment, since the recycled base fabric is used as the reinforcing portion 160b which does not directly affect the protection performance of the airbag 105, the recycled base fabric can be effectively used.

### C. Third Embodiment

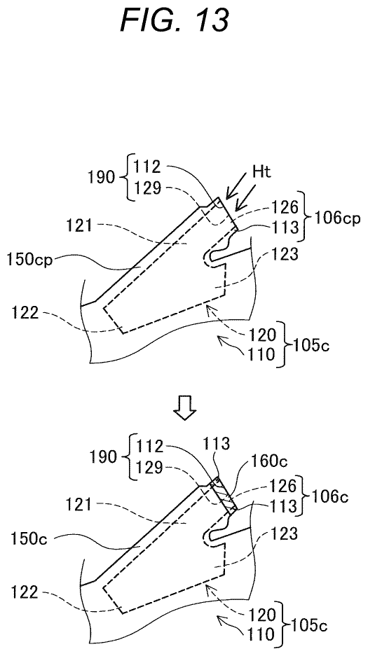

FIG. 13 is a diagram illustrating a receiving portion 150c in a third embodiment. In the third embodiment, unlike the first embodiment and the second embodiment, the reinforcing portion 160c includes a cured base fabric layer. The cured base fabric layer is a layer of a cured resin base fabric. In the present embodiment, the reinforcing portion 160c is provided in the mouth portion 106c of the airbag 105c as in the second embodiment. However, unlike the second embodiment, the reinforcing layer 161 is not disposed in the mouth portion 106c in the present embodiment. Points of the configuration of the curtain airbag device 100 in the third embodiment that are not particularly described are the same as in the second embodiment.

FIG. 13 illustrates a receiving portion 150cp not provided with the reinforcing portion 160c in addition to the receiving portion 150c. The receiving portion 150cp includes a mouth portion 106cp in a state where the reinforcing portion 160c is not provided. The reinforcing portion 160c in the present embodiment is formed by heating the mouth portion 106cp. Specifically, by curing a base fabric of the mouth portion 106cp by the heat Ht while maintaining a state where the insertion port 190 is opened in a tubular shape, the mouth portion 106c provided with the reinforcing portion 160c including the cured base fabric layer is formed. In FIG. 13, a range in which the reinforcing portion 160c is provided is schematically illustrated by hatching.

In the mouth portion 106c, for example, only one of the body distal end portion 113 and the tube distal end portion 126 may be cured, or both the body distal end portion 113 and the tube distal end portion 126 may be cured. That is, the “layer of a cured resin base fabric” may include, for example, a layer formed by curing the base fabric layer of the bag body 110 or a layer formed by curing the base fabric layer of the inner tube 120. In another embodiment, the cured base fabric layer may be formed, for example, by curing the base fabric of the mouth portion 106cp with ultraviolet rays.

According to the curtain airbag device 100 in the third embodiment described above, the reinforcing portion 160 includes a cured base fabric layer. In this way, by providing the cured base fabric layer, the reinforcing portion 160c can be formed in a more space-saving manner. Further, the reinforcing portion 160c can be formed without using the ring-shaped member 170 and while saving the base fabric.

### D. Another Embodiment

(D1) In the first embodiment, a part of the ring-shaped member 170 is disposed inside the airbag 105 via the insertion port 190, but the present invention is not limited thereto. For example, the entire ring-shaped member 170 may be disposed inside the airbag 105. Further, the entire ring-shaped member 170 may be disposed inside the insertion port 190. For example, the ring-shaped member 170 may be disposed outside a distal end portion of the receiving portion 150 to surround the insertion port 190.
(D2) In the first embodiment, the recesses 174 are provided on the outer surface of the side wall 173 of the second ring-shaped portion 172, and the recesses 174 may not be provided.
(D3) In the first embodiment, the second ring-shaped portion 172 has a polygonal outer shape when viewed in the axis AX1 direction, but the present disclosure is not limited thereto. As long as the second ring-shaped portion 172 is annular as a whole, the second ring-shaped portion 172 may have various outer shapes such as a circular shape, an elliptical shape, a semicircular shape, or a shape obtained by combining a linear shape and a curved shape, when viewed in the axis AX1 direction.
(D4) In the first embodiment, the ring-shaped member 170 has a ring shape having both ends. On the other hand, the ring-shaped member 170 may have, for example, a continuous annular shape without both ends.
(D5) In the second embodiment, the reinforcing layer 161 is provided on the tube distal end portion 126 of the inner tube 120b. On the other hand, the reinforcing layer 161 may not be provided in the tube distal end portion 126, and may be provided in the body distal end portion 113 of the bag body 110, for example. Specifically, for example, the reinforcing layer 161 may be sewn to the body distal end portion 113. Further, in the second embodiment, the reinforcing layer 161 may not be provided, and for example, the reinforcing portion 160b may be formed of a single base fabric layer forming the body distal end portion 113 and a single base fabric layer forming the tube distal end portion 126. In this case, the reinforcing portion 160b can also be formed of the plurality of base fabric layers overlapping each other.
(D6) In the second embodiment, the plurality of base fabric layers in the reinforcing portion 160b are formed of different base fabrics. Without being limited thereto, at least a part of the plurality of base fabric layers in the reinforcing portion 160b may be formed by folding one base fabric, for example.
(D7) In the second embodiment, the reinforcing portion 160b may not include the recycled base fabric layer.
(D8) In the third embodiment, the reinforcing portion 160c may include a recycled base fabric layer. The reinforcing portion 160c may include a plurality of base fabric layers.
(D9) In the above embodiments, the insertion port 190 is formed by the body opening 112 and the tube opening 129. On the other hand, the insertion port 190 may not be formed of the body opening 112 and the tube opening 129, and may be formed by, for example, only one of the body opening 112 and the tube opening 129. When the insertion port 190 is formed only by the body opening 112, the airbag 105 may not include the inner tube 120.
(D10) The reinforcing portion may be formed of, for example, a single base fabric layer. For example, when the insertion port 190 is configured only by the body opening 112 as described above, the body distal end portion 113 may include a single base fabric layer as the base fabric layer, and the single base fabric layer of the body distal end portion 113 may function as a reinforcing portion. In this case, the single base fabric layer may be a recycled base fabric layer. Further, it is preferable that the body distal end portion 113 is formed of a recycled base fabric, and a portion of the bag body 110 different from the body distal end portion 113 is formed of a non-recycled base fabric. The recycled base fabric forming the body distal end portion 113 and the non-recycled base fabric forming the portion different from the body distal end portion 113 are joined to each other by, for example, sewing or welding. In this way, the recycled base fabric can be effectively used as in the second embodiment. In addition, for example, when the insertion port 190 is configured only by the tube opening 129, the tube distal end portion 126 may be configured to include a single base fabric layer as a base fabric layer, and the single base fabric layer of the tube distal end portion 126 may function as a reinforcing portion. In this case, substantially as in the case of the bag body 110, the single base fabric layer may be a recycled base fabric layer.
(D11) In each of the above embodiments, the vehicle 200 is illustrated as an example of a moving body. On the other hand, the moving body is not limited to the vehicle 200, and may be various moving bodies. For example, the moving body may be various moving bodies on which an occupant can ride, and may be a ship, a flight machine, a space ship, a so-called flying vehicle, or the like.

The present disclosure is not limited to the above embodiments, and may be implemented by various configurations without departing from the gist of the present disclosure. For example, the technical features in the embodiments corresponding to the technical features in the aspects described in the summary of the invention may be replaced or combined as appropriate to solve a part or all of the above-described problems or to achieve a part or all of the above-described effects. The technical features may be appropriately deleted unless being described as necessary in the present specification.

What is claimed is:

1. A curtain airbag device for a moving body, the curtain airbag device comprising:
an airbag configured to be inflated and deployed by being supplied with inflation gas from an inflator, the airbag having an insertion port into which the inflator is inserted; and
a reinforcing portion that reinforces the insertion port to maintain an open state where the insertion port is opened in a cylindrical shape.

2. The curtain airbag device according to claim 1, wherein
the reinforcing portion is formed of a ring-shaped member, and
at least a part of the ring-shaped member is disposed in the insertion port.

3. The curtain airbag device according to claim 2, wherein
the ring-shaped member includes a first ring-shaped portion and a second ring-shaped portion connected to the first ring-shaped portion in an axial direction of the ring-shaped member,
the first ring-shaped portion is disposed inside the airbag via the insertion port, and
the second ring-shaped portion is disposed outside the airbag.

4. The curtain airbag device according to claim 3, wherein
a recess is provided on an outer surface of a side wall of the second ring-shaped portion.

5. The curtain airbag device according to claim 3, wherein
the second ring-shaped portion has a polygonal outer shape when viewed in the axial direction.

6. The curtain airbag device according to claim 2, wherein
the ring-shaped member has a ring shape having both ends.

7. The curtain airbag device according to claim 1, wherein
the reinforcing portion is formed of a plurality of layers of base fabrics overlapping each other.

8. The curtain airbag device according to claim 7, wherein
the reinforcing portion is provided in a mouth portion of the airbag including a distal end on the insertion port side, and
the number of layers of the base fabric in the mouth portion is larger than the number of layers of the base fabric in a portion of the airbag different from the mouth portion.

9. The curtain airbag device according to claim 1, wherein
the reinforcing portion includes a layer of a base fabric formed of a recycled resin.

10. The curtain airbag device according to claim 1, wherein
the reinforcing portion includes a layer of a base fabric formed of a cured resin.
